(19) United States
(12) Patent Application Publication
(10) Pub. No.: US 2026/0046122 A1
(43) Pub. Date: Feb. 12, 2026

(54) SYSTEM AND METHOD FOR HACKER MONITORING, LEARNING, AND PREVENTION SYSTEM AND SECURE DATA STORAGE

(71) Applicant: AppsCo Inc., Cottleville, MO (US)

(72) Inventors: Geir Christian Karlsen, Yven (NO); Johan Idzinga, Utrecht (NL); Bård Frode Rønningen, Belgrade (RS)

(21) Appl. No.: 19/293,422

(22) Filed: Aug. 7, 2025

Related U.S. Application Data
(60) Provisional application No. 63/680,518, filed on Aug. 7, 2024.

(51) Int. Cl. H04L 9/08; H04L 9/14; H04L 9/40

(52) U.S. Cl. CPC H04L 9/0861; H04L 9/0894; H04L 9/14; H04L 63/0478; H04L 63/1425; H04L 63/1491

(57) ABSTRACT

One variation of the method includes: at an application, accessing a data stream, encrypting the data stream, and passing the data stream to a data protection tool; at the data protection tool, encrypting the data stream and passing the data stream to a data store; and at the data store, encrypting the data stream; and storing the data stream. This variation of the method also includes, at the application: receiving a request to access the data stream from a first entity; accessing a set of user attributes representing an authentic user; accessing a set of entity attributes; calculating a first trust score for the entity based on the set of user attributes and the set of entity attributes; and, in response to the first trust score falling below a first threshold trust score, generating a decoy data stream and serving the decoy data stream to the entity.

### CROSS-REFERENCE TO RELATED APPLICATIONS

This Application claims the benefit of U.S. Provisional Application No. 63/680,518, filed on 07-AUG-2024, which is incorporated in its entirety by this reference.

### TECHNICAL FIELD

This invention relates generally to the field of digital resource storage and, more specifically, to a new and useful method for securing data and preventing unauthorized access in the field of digital resource storage.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method; and

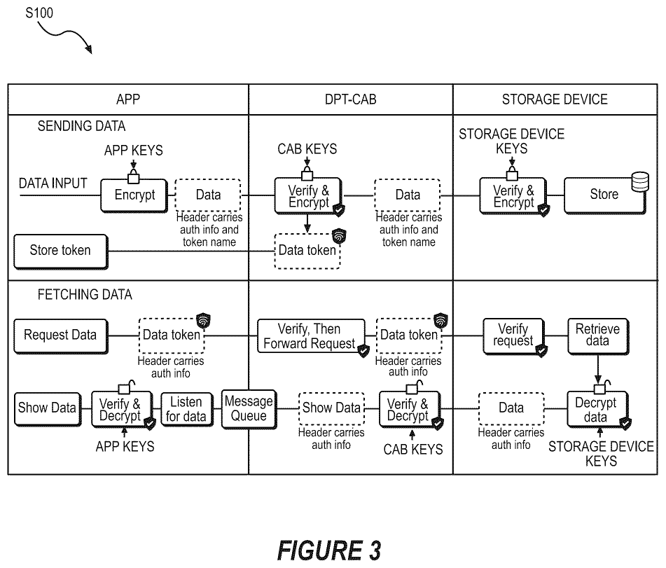

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

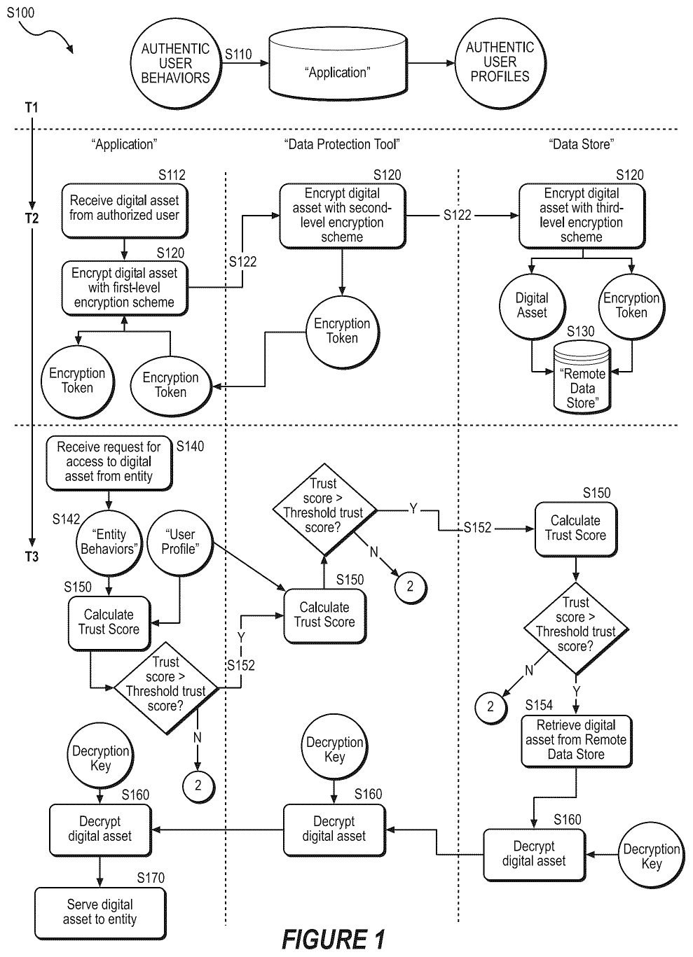

As shown in FIG. 1, a method S100 includes, during a first time period: recording a first set of user behaviors representing authentic interactions between a first user and devices hosted by a computer network in Block S110; at an application executing on a first device in the computer network, accessing a digital resource in Block S112, encrypting the digital resource according to a first encryption scheme in Block S120, and passing the digital resource to a data protection tool in Block S122; at the data protection tool, encrypting the digital resource according to a second encryption scheme in Block S120 and passing the digital resource to a data store in Block S122; and, at the data store, encrypting the digital resource according to a third encryption scheme in Block S120 and storing the digital resource encrypted according to the first encryption scheme, the second encryption scheme, and the third encryption scheme in Block S130.

The method S100 also includes, during a second time period and at the application: receiving a request to access the digital resource from a first entity in Block S140; recording a first set of entity behaviors representing interactions between the first entity and the application in Block S142; calculating a first trust score for the entity based on similarities between the first set of user behaviors and the first set of entity behaviors in Block S150; and, in response to the first trust score exceeding a first threshold trust score, passing the request to the data protection tool in Block S152. The method S100 further includes, at the data protection tool: calculating a second trust score for the entity based on similarities between the first set of user behaviors and the first set of entity behaviors in Block S150; and, in response to the second trust score exceeding a second threshold trust score, passing the request to the data store in Block S152. The method S100 also includes, at the data store: calculating a third trust score for the entity based on similarities between the first set of user behaviors and the first set of entity behaviors in Block S150; and, in response to the third trust score exceeding a third threshold trust score, accessing the digital resource in Block S154, decrypting the digital resource according to the third encryption scheme in Block S160, and passing the digital resource to the data protection tool in Block S162.

The method S100 further includes: at the data protection tool, in response to receipt of the digital resource from the data store, decrypting the digital resource according to the second encryption scheme in Block S160 and passing the digital resource to the application in Block S162; and, at the application, in response to receipt of the digital resource from the data protection tool, decrypting the digital resource according to the first encryption scheme in Block S160 and serving the digital resource to the first entity in Block S170.

### 1.1 Variation: Live Data Storage+Distribution

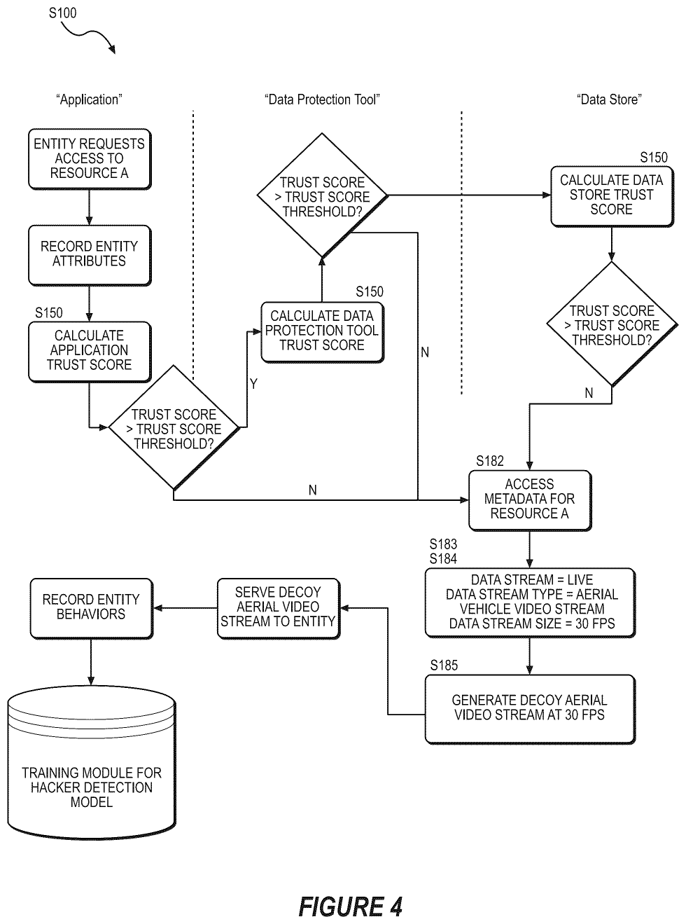

As shown in FIG. 4, one variation of the method S100 includes, during a first time period: generating a first set of user attributes representing an authentic user for a computer network in Block S110; at an application executing on a first device in the computer network, accessing a live data stream in Block S112, encrypting the live data stream according to a first encryption scheme in Block S120, and passing the live data stream to a data protection tool in Block S122; at the data protection tool, encrypting the live data stream according to a second encryption scheme in Block S120 and passing the live data stream to a data distribution system in Block S122; and, at the data distribution system, encrypting the live data stream according to a third encryption scheme in Block S120, and hosting the live data stream encrypted according to the first encryption scheme, the second encryption scheme, and the third encryption scheme in Block S122.

This variation of the method S100 also includes, during a second time period: at the application, receiving a request to access the live data stream from a first entity in Block S140, recording a first set of entity attributes in Block S142, calculating a first trust score for the entity based on similarities between the first set of user attributes and the first set of entity attributes in Block S150, and, in response to the first trust score exceeding a first threshold trust score, passing the request to the data protection tool in Block S152; at the data protection tool, calculating a second trust score for the entity based on similarities between the first set of user attributes and the first set of entity attributes in Block S150 and, in response to the second trust score exceeding a second threshold trust score, passing the request to the data distribution system in Block S152; and, at the data distribution system, calculating a third trust score for the entity based on similarities between the first set of user attributes and the first set of entity attributes in Block S150 and, in response to the third trust score exceeding a third threshold trust score, accessing the live data stream in Block S154, decrypting the live data stream according to the third encryption scheme in Block S160, and passing the live data stream to the data protection tool in Block S162. This variation of the method S100 further includes, at the data protection tool, in response to receipt of the live data stream from the data store: decrypting the live data stream according to the second encryption scheme in Block S160; and passing the digital resource to the application in Block S162. This variation of the method S100 further includes, at the application, in response to receipt of the live data stream from the data protection tool: decrypting the live data stream according to the first encryption scheme in Block S160; and streaming the data store for the first entity in Block S170.

### 1.2 Variation: Live Decoy Data Generation

As shown in FIG. 4, one variation of the method S100 includes generating the decoy data stream of the data stream type including: accessing a set of data stream characteristics from metadata associated with the data stream in Block S182; identifying a data stream type from the set of data stream characteristics in Block S183; identifying a data size of the data stream from the set of data stream characteristics in Block S184; and generating the decoy data stream of the data size and the data stream type in Block S185.

### 1.3 Variation: User Profiles

As shown in FIG. 1, a method S100 includes, at a first time, at an application executing on a local computing device: recording a first corpus of user behaviors representing interactions between the user and the local computing device; and generating a user profile representing authentic behaviors of the user based on the first corpus of user behaviors in Block S110.

The method S100 further includes, at a second time: at the application, receiving a digital resource for storage, encrypting the digital resource in Block S120 according to a first encryption scheme, and passing the digital resource to a data protection system; at a data protection system, encrypting the digital resource in Block S120 according to a second encryption scheme and passing the digital resource to a data store; at a data store, encrypting the digital resource in Block S120 according to a third encryption scheme; and storing the digital resource in Block S130 encrypted according to the first encryption scheme, the second encryption scheme, and the third encryption scheme.

The method S100 further includes, at a third time, at the application: receiving a request to access the digital resource from an entity in Block S140; recording a first corpus of entity behaviors representing interactions between the entity and the local computing device; calculating a first trust score for the entity in Block S150 based on similarities between the user profile and the first corpus of entity behaviors and a hacker detection model; and, in response to the first trust score exceeding a threshold trust score, passing the request to the data protection tool. The method S100 also includes, at the third time, at the data protection tool: calculating a second trust score for the entity in Block S150 based on similarities between the user profile and the first corpus of entity behaviors and the hacker detection model; and, in response to the second trust score exceeding the threshold trust score, passing the request to the data store. The method S100 further includes, at the third time, at the data store: calculating a third trust score for the entity in Block S150 based on similarities between the user profile and the first corpus of entity behaviors and the hacker detection model; and, in response to the third trust score exceeding the threshold trust score, accessing the digital resource, decrypting the digital resource in Block S160 according to the third encryption scheme, and passing the digital resource to the data protection tool.

The method S100 also includes, at the third time: at the data protection tool, in response to receipt of the digital resource from the data store and in response to the second trust score exceeding the threshold trust score, decrypting the digital resource in Block S160 according to the second encryption scheme and passing the digital resource to the application; at the application, in response to receipt of the digital resource from the data protection tool and in response to the first trust score exceeding the threshold trust score, decrypting the digital resource in Block S160 according to the first encryption scheme; and serving the digital resource to the entity in Block S170.

### 1.4 Variation: Distributed Voting Engine

In one variation, calculating the first trust score for the entity at the application includes: in response to receiving the request to access the digital resource from the entity, selecting a first subset of remote machines from a network of remote machines; for each remote machine in the first subset of remote machines, sending a request for a trust score to the remote machine, sending the first corpus of entity behaviors to the remote machine, and receiving a trust score, in a first set of trust scores, from the remote machine; and calculating the first trust score based on a composite of the first set of trust scores.

In this variation, calculating the second trust score for the entity at the data protection tool includes: in response to receiving the request to access the digital resource from the application, selecting a second subset of remote machines from the network of remote machines; for each remote machine in the second subset of remote machines, sending a request for a trust score to the remote machine, sending the first corpus of entity behaviors to the remote machine, and receiving a trust score, in a second set of trust scores, from the remote machine; and calculating the second trust score based on a composite of the second set of trust scores.

In this variation, calculating the third trust score for the entity at the data store includes: in response to receiving the request to access the digital resource from the data protection tool, selecting a third subset of remote machine from a network of remote machines; for each remote machine in the third subset of remote machines, sending a request for a trust score to the remote machine, sending the first corpus of entity behaviors to the remote machine, and receiving a trust score, in a third set of trust scores, from the remote machine; and calculating the third trust score based on a composite of the third set of trust scores.

### 1.5 Variation: Continuous Behavior Streaming

In one variation, the method S100 includes, at the application, following recordation of the first corpus of entity behaviors: recording a second corpus of entity behaviors representing subsequent interactions between the entity and the local computing device; and, in response to the first trust score exceeding the trust score threshold, passing the first corpus of entity behaviors and the second corpus of entity behaviors to the data protection tool.

In this variation, calculating the second trust score at the data protection tool includes calculating the second trust score based on: the first corpus of entity behaviors; and the second corpus of entity behaviors.

In this variation, the method S100 includes, at the application, following recordation of the second corpus of entity behaviors: recording a third corpus of entity behaviors; and passing the first corpus of entity behaviors, the second corpus of entity behaviors, and the third corpus of entity behaviors to the data store.

In this variation, calculating the third trust score at the data store includes calculating the third trust score based on: the first corpus of entity behaviors; the second corpus of entity behaviors; and the third corpus of entity behaviors.

### 1.6 Variation: Decoy Digital Resource Return

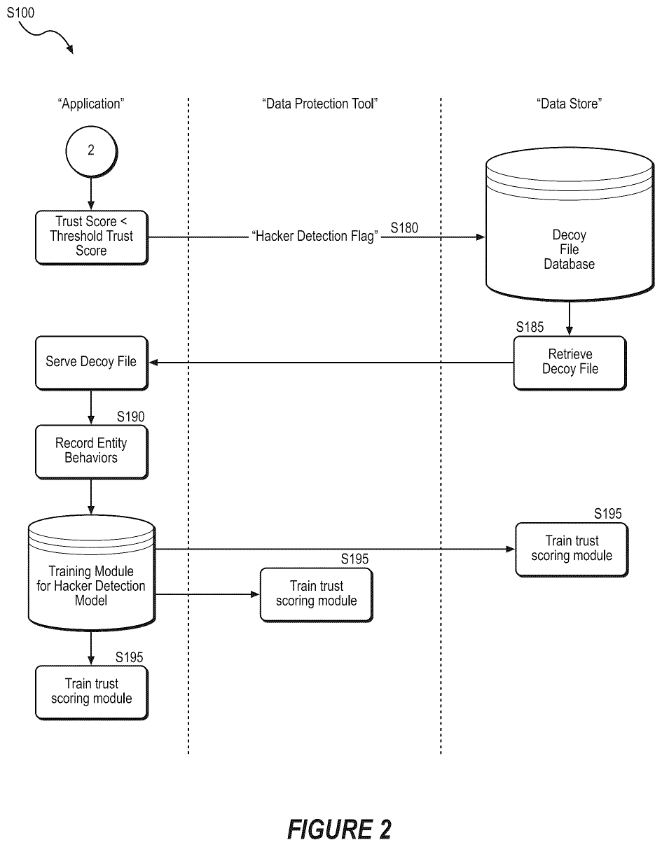

As shown in FIG. 2, in one variation, the method S100 includes: in response to the first trust score falling below the threshold trust score, at the application, passing a hack detection flag to the data store in Block S180; in response to the second trust score falling below the threshold trust score, at the data protection tool, passing the hack detection flag to the data store; and/or in response to the third trust score falling below the threshold trust score, at the data store, generating the hack detection flag.

In this variation, the system further includes: at the data store, in response to receiving the hack detection flag, retrieving a decoy digital resource in Block S185 and returning the decoy digital resource to the application in place of the digital resource; at the application, delivering the decoy digital resource to the entity and recording a fourth corpus of entity behavior following delivery of the decoy digital resource to the entity in Block S190; and updating a hacker detection model for identifying hackers based on behaviors in the fourth corpus of entity behavior in Block S195.

### 2. Applications

Generally, the method S100 can be executed by an application (e.g., a native or browser-based application) executing on a user's local device (e.g., a smartphone, a laptop, and desktop, and endpoint device) in cooperation with a data protection tool executing on a centralized or distributed remote computer system or other computer network and a data store executing on the same or other centralized or distributed remote computer system or other computer network (hereinafter the “computer system”): to collect and store authentic user-to-device interactions (or “authentic behaviors”) of a user; to securely and remotely store a digital resource for a user; to check authenticity of an entity attempting access to the digital resource based on similarities between behaviors of the entity and authentic behaviors of the user; to either return the digital resource to the entity responsive to this request if the entity is authenticated or return a decoy (or “fake”) digital resource to the entity responsive to this request if the entity is not authenticated; and to update a model for detecting hackers based on the entity's interactions with the decoy digital resource.

In one example, the computer system can: store authentic user profiles representing attributes (e.g., behaviors, locations, characteristics, login credentials, biometric identifiers) for authentic users associated with a computer network; receive a digital resource (e.g., file, live data stream, database) for secure storage within the computer network; and triply encrypt the digital resource and remotely store encryption keys for these encryptions. In particular, the computer system can triply encrypt the digital resource at a local application, a cloud-based data protection tool, and a data store storing the digital resource. Then, the application can receive a request to view or otherwise retrieve this digital resource from an entity. The application can collect entity attributes from the entity attempting to access the digital resource and compare these entity attributes to attributes in authentic user profiles to validate the entity. In response to validation of the entity at the application, the application can stream these entity attributes (e.g., continuous behavior streaming, passing a set of entity attributes) to the data protection tool. The data protection tool can then compare these entity attributes to attributes in authentic user profiles to validate the entity. In particular, in this example, the data protection tool can define a lower risk tolerance than the application and thus reject entities that may have passed security checks at the application. In response to validation of the entity at the data protection tool, the application and the data protection tool can stream entity attributes (e.g., continuous behavior streaming, passing a set of entity attributes) to the data store. The data store can then compare these entity attributes to attributes in authentic user profiles to validate the entity. In particular, in this example, the data store can define a lower risk tolerance than the application and the data protection tool, and thus reject entities that may have passed security checks at the application and the data protection tool. In particular, in response to an entity failing a security check (e.g., trust score calculation) at any of the application, data protection tool, or data store, the system can: access a decoy digital resource (e.g., a decoy digital resource approximating the digital resource the entity is attempting to access); and serve the decoy digital resource to the entity in replacement of the (real) digital resource.

In particular, the computer system can serve the decoy digital resource such that the entity (e.g., a hacker, a bad actor) may perceive to have obtained target sensitive information and, therefore, cease their attack on the computer network without gaining information about the computer network's security system. Thus, the system can implement a robust security solution by combining decentralized key management, advanced encryption, blockchain integration, tokenization, and AI-driven policy management to prevent data breaches and ensure data integrity across various applications. Furthermore, the system can include a hacker detection model implementing a dynamic learning component, which thus enables the system to improve digital resource and data security by learning from hacker access attempts.

### 2.1 Digital Resource Release to Authentic Entity

In particular, the application, the data protection tool, and the data store can cooperate: to securely store a digital resource, for a user, with nested encryption of the digital resource by these systems; to control access to the digital resource by an entity based on the entity's interactions with a device, such as instead of or in addition to a username and password; to decentralize validation or rejection of the entity as the user or a hacker, respectively, based on multiple (serial or parallel) comparisons of authentic user behaviors to entity behaviors at multiple distinct machines; and to serve the digital resource to the entity only if the entity is validated by these multiple machines. Thus, the application, the data protection tool, and the data store can individually and serially: encrypt a digital resource prior to storage; test entity behaviors against known authentic behaviors of a valid user when the entity later requests access to the digital resource; “vote” on access to the digital resource by the entity based on results of their individual tests; and selectively decrypt the digital resource to control access to the digital resource by the entity. Accordingly, the application, the data protection tool, and the data store can decentralize encryption, storage, and entity validation, thereby preventing hackers from accessing the digital resource (e.g., containing sensitive information) without concurrently hacking and controlling all of the application, the data protection tool, and the data store.

### 2.2 Decoy Digital Resource for Inauthentic Entity

Furthermore, the application, the data protection tool, and the data store can execute Blocks of the method S100: to return a decoy digital resource (e.g., analogous to the original digital resource) to the entity if the entity is not authenticated as the user, thereby avoiding indication of detection to the entity such that the entity handles the decoy digital resource as authentic; and to track interactions of the entity with the decoy digital resource and the device (e.g., “hacker behaviors”) following receipt of the decoy digital resource. After identifying an entity as inauthentic and thus a likely hacker, the application, the data protection tool, and the data store can thus: capture real behaviors of a likely hacker following receipt of information that the hacker perceives as genuine; and expand or retrain a model for detecting a hacker based on these hacker behaviors.

### 2.3 Expanded Entity Behavior Set+Model Size

In particular, the application, the data protection tool, and the data store can execute Blocks of the method S100 during a first time period to: generate a user profile that represents authentic user behaviors (e.g., user inputs) into a local device by an authenticated user; to access a digital resource at the local device; to encrypt the digital resource in triplicate (i.e., with a first encryption scheme implemented by the application, a second encryption scheme implemented by the data protection tool, and a third encryption scheme implemented by the data store); and to store the digital resource remotely from the device. During a second time period, the application executes Blocks of the method S100 to: receive a request for access to the digital resource by an entity; and collect a first set of behaviors of the entity interacting with the local device before, during, and/or (shortly) after entering the request for the digital resource.

In one implementation, the application: executes a small hacker detection model—exhibiting high speed and requiring minimal computational resources—to calculate a first trust score representing a similarity (or difference) between authentic user behaviors represented in the user profile and the first set of entity behaviors; and continues to collect entity behaviors. If this first trust score exceeds a threshold, the application: serves an expanded second set of entity behaviors and a request to access the digital resource to the data protection tool.

The data protection tool then executes a larger hacker detection model—exhibiting lower speed and requiring more computational resources—to calculate a second trust between authentic user behaviors represented in the user profile and this expanded second set of entity behaviors. If this second trust score exceeds the same (or other) threshold, the data protection tool: receives additional user behaviors from the application; and serves an expanded third set of entity behaviors to the data store.

The data store then executes an even larger hacker detection model—exhibiting even lower speed and requiring even more computational resources—to calculate a third trust score between authentic user behaviors represented in the user profile and this expanded third set of entity behaviors. If this third trust score exceeds the same (or other) threshold, the data store: retrieves the digital resource; decrypts the digital resource according to the data store's third decryption key; and returns the digital resource to the data protection tool for further handling.

The data protection tool then: decrypts the digital resource according to the data protection tool's second decryption key; generates a token for access to a first decryption key; and returns the token and the digital resource to the application for further handling. The application then: retrieves a first decryption key based on the token;

decrypts the digital resource according to the this first decryption key; and serves the fully-decrypted digital resource to the entity.

Thus, in this implementation, the application, the data protection tool, and the data store can: implement a small, lightweight, lower-accuracy model for detecting a hacker based on behavioral differences at the application responsive to a request to access the digital resource; pass the request to the data protection tool for execution of a moderately-sized, moderate-accuracy model requiring more computational resources to detect a hacker only if the small, lightweight, lower-accuracy model clears the request; and pass the request to the data store for execution of a large, high-accuracy model requiring even more computational resources to detect a hacker only if the moderately-sized, moderate-accuracy model also clears the request. The application, the data protection tool, and the data store can thus efficiently deploy local and remote resources to handle and resolve a digital resource access request and to detect a hacker attempting to access the digital resource.

Furthermore, the application, the data protection tool, and the data store can leverage latency in executing these models to collect additional entity behaviors, which the data protection tool and the data store can then further pass into their hacker detection models to return higher-accuracy trust scores for the entity.

### 2.4 Decentralized Behavior Characterization+Voting

Additionally or alternatively, following receipt of a request to access a digital resource, the application can: (pseudo)pseudorandomly select a subset of remote machines—in a decentralized network—to calculate trust scores for the entity; serve a set of entity behaviors to this subset of machines; and derive or calculate a composite trust score for the entity based on a combination (e.g., an average) of trust scores received from each of these machines executing an instance of the hacker detection model; and selectively return a request for the digital resource to the data protection tool based on this composite trust score.

Thus, in this implementation, the application can further secure access to the digital resource from the hacker by requiring the hacker to either infiltrate all machines in the decentralized network to return corrupted trust scores or accurately “guess” the subset of machines that the application will rely on for remote calculation of trust scores, each of which may represent an undue or impossible burden for the hacker.

The data protection tool and the data store can implement similar methods and techniques to derive or calculate their own composite trust scores for the entity based on trust scores received from their own, different selections of machines within the decentralized network, thereby further securing the digital resource. Thus, the system can integrate artificial intelligence models, biometrics, user behaviors, blockchain, and third-party applications into calculation of the trust score.

### 2.5 Other Data

The method S100 is described herein as executed by the application, the data protection tool, and the data store to control access to a digital resource containing sensitive information and to serve a decoy digital resource to an invalid entity (or “hacker”) attempting to access this digital resource.

However, the application, the data protection tool, and the data store can implement similar methods and techniques to control access to other types of data, such as: live data streams, data streams, objects, usernames and passwords; banking information; investment accounts; emails; electronic health information; an employee or organization database; etc. Additionally or alternatively, the application, the data protection tool, and the data store can implement similar methods and techniques to control access to remote login or remote access of a local device, an endpoint device, or other machine. In these implementations, the application, the data protection tool, and the data store can implement similar methods and techniques to: serve decoy video streams, decoy usernames, passwords, banking information, investment accounts, email, electronic health information, employee or organization databases, and/or remote access controls, etc. to an entity thus identified as inauthentic (e.g., a “hacker”); to capture hacker behaviors of the entity with this decoy content; and to develop or refine models for identifying hackers based on their behaviors.

### 3. System

Generally, the system includes: a digital resource management application (hereinafter the “application”); a data protection tool; and a data store.

The application executes on a local device (e.g., a mobile device, a laptop, a tablet or other endpoint) and can include: a native application; a browser-based application; and/or a digital resource security widget integrated into a native application or web browser; etc.

The data protection tool can: function as an intermediary digital resource protection service, such as executing on a computer network; function as a third party between the application and the data store; and/or execute at a remote server or remote cloud database. For example, the data protection tool can define a web service executing Blocks of the method S100 across a network of servers or remote assets.

The data store can: define a service affiliated with the application and the data protection tool; and/or execute within a digital resource management system. In one implementation, the data store is coextensive with the data protection tool, such as executing on assets within a computer network also executing the data protection tool. In another implementation, the data store executes within a separate remote computer network, such as a centralized or decentralized cloud-based storage system.

### 4. User Profile+Authentic Attributes

Generally, the system can generate a user profile for an authenticated user interfacing with a device executing the application. In particular, the system can: detect a set of behaviors (or “behavior signals”) in a set of behavioral domains as the user interfaces with the device; aggregate the set of behaviors into a behavior profile representing combinations of behaviors characteristic of authenticated user behavior; and associate the behavior model with the authenticated user.

In one implementation, while the user is logged in and authenticated at the user's device, the application records user behaviors in a set of behavioral domains including: biometric data (e.g., fingerprint scan, facial recognition); user inputs (e.g., screen orientations, gestures, touch locations, cursor locations, touch or cursor paths, palm rests, local device motion); geospatial location of the local device; window, folder, and/or application-level navigation patterns; interactions with or execution of other active applications on the local device; digital resource request type and frequency; request load on the local device; user interaction sources (e.g., local or virtual); and environment (e.g., local device temperature, local device battery state of charge, ambient conditions around local device).

Generally, the system can: detect and record representations of authentic (user) interactions at a local device (e.g., at the application, a mobile device, a laptop) over time; and compile these behaviors into a behavior model that represents ranges of values within a combination of behavioral domains representative of (e.g., common to, typical of) behaviors performed by the authenticated user. The application can then: associate the behavior model with the authenticated user and the user's account; and store a local copy of the behavior model in local memory and/or serve the behavior profile to the data protection tool, the data store, the remote machine in the network of remote machines, and/or blocks in a blockchain.

Additionally or alternatively, the computer system can (e.g., via the application): generate or collect a set of attributes associated with authentic users in the computer network; and generate user profiles based on the set of attributes. In particular, the computer system can identify a set of attributes for an authentic user including: a set of login credentials (e.g., username, password); a location; a device; a device type; and/or any other type of identifying attribute associated with the authentic user. For example, the computer system (e.g., the application) can: access a first location for the authentic user; access a first set of login credentials for the authentic user; and aggregate the first location and the first set of login credentials into the first set of user attributes.

In one implementation, the system includes multiple instances of the application, each executing on one device (e.g., of different device types, such as a smartphone, smartwatch, tablet, laptop, and/or desktop computer) affiliated with the user. In this implementation, each instance of the application can execute similar methods and techniques to generate one behavior model: specific to the authenticated user and the particular device type; and based on user behaviors detected by the instance of the application at the device of the particular device type. For example, for each instance of the application executing on the device of the unique device type, the application can: associate the behavior model with the user account and the particular device time; and store the behavior model remotely on a (centralized or decentralized) remote database. At a second time, in response to an entity accessing the user account at a device of a particular type and entering a request for a digital resource, the instance of the application executing on this device can: retrieve the corresponding behavior model—associated with the user and the particular device type—from the remote database.

Therefore, the system can: construct a model representing authentic user behaviors over time and characterize access attempts based on similarities (or differences) between user behaviors and entity behaviors to identify an entity as authenticated or invalid.

### 5. Digital Resource Storage

Generally, the system can store a corpus of authentic digital resources via a three-stage encryption process. In particular, the application can: receive an authentic digital resource; encrypt the authentic digital resource with a first level of encryption; generate a first decryption key (or token) associated with the first level of encryption; send the first decryption key to a remote computer system for remote storage; and pass the digital resource to the data protection tool. The data protection tool can then: receive the digital resource; verify that the digital resource was received from an authentic user (e.g., a user with permission to upload digital resources to the data protection tool); encrypt the digital resource with a second level of encryption; generate a second decryption key or token associated with the second level of encryption; send the second decryption key to the same or other remote computer system for remote storage; pass (and/or store) the second decryption key or token to the application; and pass the digital resource to the data store. The data store can then: receive the digital resource; verify that the digital resource was received from an authentic user (e.g., a user with permission to upload digital resources to the data store); encrypt the digital resource with a third level of encryption; generate a third decryption key or token associated with the third level of encryption; send the third decryption key to the same or other remote computer system for remote storage; and store the digital resource and the third decryption key or token on the data store.

In one implementation, the computer system can pseudorandomly select devices and/or machines within the computer network for storage of the digital resource and/or encryption keys associated with the digital resource. For example, the computer system can: access a population of devices associated with the computer network; pseudorandomly select a second device in the population of devices; pass the digital resource to the data protection tool at the second device; pseudorandomly select a third device in the population of devices; and pass the digital resource to the data protection tool at the third device.

In another example, the computer system can: access a population of devices associated with the computer network; pseudorandomly select a second device in the population of devices; store a first encryption key, for the first encryption scheme, at the second device; pseudorandomly select a third device in the population of devices; store a second encryption key, for the second encryption scheme, at the third device; pseudorandomly select a fourth device in the population of devices; and store a third encryption key, for the third encryption scheme, at the fourth device.

In the foregoing examples, the computer system can pseudorandomly select the application, the data protection tool, and/or the data store for pseudorandom selection of a device or machine on which to store the encryption key.

Therefore, the system can triply encrypt the digital resource at each of three different systems by generating three unique keys (or tokens) that are each required—in the correct order—to later decrypt the digital resource once accessed from the data store. Additionally, the system can distribute each unique key (or token)—for remote storage—to a different computer within a distributed computer network. Therefore, the system can: limit a likelihood that a potential hacker may identify and gain unauthorized access to each computer within the computer network storing the keys necessary to decrypt the digital resource; and thereby further securing the digital resource from unauthorized access.

### 6. Digital Resource Retrieval: Downstream Behavior Characterization

Generally, the system can implement downstream behavior characterization and upstream digital resource decryption at the application, the data protection tool, and the data store. The application can: collect a first corpus of entity behaviors leading up to and/or including a request for access to a digital resource; calculate an application-level trust score for the entity based on these behaviors and the user profile, such as stored in local memory or retrieved from a remote database; and pass the request for the digital resource to the data protection tool in response to the trust score for the entity exceeding a threshold trust score.

The data protection tool can: receive the request for the digital resource and the first corpus of entity behaviors from the application; receive the user profile (e.g., directly from the application); in response to receiving a user identifier from the application, retrieve the user profile directly from a remote database; calculate a data protection tool-level trust score for the entity based on the first corpus of entity behaviors and the user profile; and pass the request for the digital resource to the data store in response to the data protection tool-level trust score for the entity exceeding the threshold trust score.

The data store can: receive the request for the digital resource and the first corpus of entity behaviors from the data protection tool; receive the user profile (e.g., directly from the application and/or the data protection tool); in response to receiving a user identifier from the data protection tool, retrieve the user profile directly from the remote database; calculate a data store-level trust score for the entity based on the first corpus of entity behaviors and the user profile; decrypt the digital resource with the data store-decryption key (or token) in response to the data store-level trust score for the entity exceeding the threshold trust score; and pass the digital resource to the data protection tool. The data protection tool can then: decrypt the digital resource with the data protection tool-decryption key or token and pass the digital resource to the application, such as in response to the prior (or revised) data store-level trust score for the entity exceeding the threshold trust score. The application can then: decrypt the digital resource with the application-decryption key (or token); and serve the digital resource to the entity, such as in response to the prior (or revised) application-level trust score for the entity exceeding the threshold trust score.

### 6.1 Entity Behavior Collection

Generally, the application can detect (or record) behaviors and/or attributes representing an entity's interactions with the device (e.g., the authenticated user, an unauthorized in-person user with physical access to the device, or a remote human or artificial intelligence hacker), including: biometric data (e.g., screen orientation, gestures, touch or cursor locations); geospatial location and time data; navigation patterns such as through windows; identifying other active applications; digital resource request frequency; request load on engine; virtual behaviors (e.g., emulated inputs identified via a feed of inputs; inputs virtually injected into a sensor stream read from a physical sensor); and behavior environment (e.g., physical, virtual). The application (or the system more generally) can then aggregate the recorded behaviors into a first corpus of entity behaviors.

In one implementation, the computer system can continuously stream behaviors and/or attributes recorded by the application to the data protection tool and the data store (and/or data distribution system) while the data protection tool and the data store calculate trust scores for the first entity.

In particular, the application can: after calculation of the first trust score, stream a second set of entity behaviors representing interactions between the entity and the application to the data protection tool; and, after calculation of the second trust score to the data store, stream a third set of entity behaviors representing interactions between the entity and the application.

The data protection tool can then calculate the second trust score for the entity based on: similarities between the first set of user behaviors and the first set of entity behaviors; and similarities between the first set of user behaviors and the second set of entity behaviors. Similarly, the data store can calculate the third trust score for the entity based on: similarities between the first set of user behaviors, the first set of entity behaviors, the second set of entity behaviors, and the third set of entity behaviors.

Therefore, the application can record (or detect, collect, generate) entity behaviors once an entity logs in to or otherwise accesses the device. Following a request to access a digital resource at the device, the application (or the system more generally) can then: package these entity behaviors for comparison against the user profile; and execute Blocks of the method to calculate a trust score of the entity before returning the requested digital resource or a decoy digital resource to the entity.

### 6.2 Downstream App-Side Entity Behavior Characterization+Query Release

In one implementation, the application (or another remote element of the system) can: access a first corpus of entity behaviors; and access the user profile generated for the user, such as stored in local memory or a remote database. For each behavioral domain in the set of behavioral domains represented in the user profile, the application can then characterize a magnitude of behavioral difference between the behavioral domain represented in the user profile and the corresponding behavior represented in the first corpus of entity behaviors based on a hacker detection model. The application can then calculate a trust score—for the entity requesting access to the digital resource—inversely proportional to a combination (e.g., a sum, an average) of the magnitudes of behavioral differences in the set of behavioral domains based on a trust scoring module of the hacker detection model.

In one implementation, the computer system (e.g., the application) can: receive a first request to access a digital resource (e.g., data stream); access a set of entity attributes associated with the first request; and calculate a trust score for the entity based on association between the set of entity attributes and a set of authentic user attributes.

For example, the application can: access a second location for the entity; access a second set of login credentials for the entity; calculate a first similarity between the first location for the authentic user and the second location for the entity; calculate a second similarity between the first set of login credentials for the authentic user and the second set of login credentials for the entity; and calculate the first trust score proportional to the first similarity and the second similarity.

Additionally or alternatively, the method described herein can be executed by the data protection tool, and/or the data store.

### 6.3 Downstream Data Protection Tool Behavior Characterization+Query Release

Generally, the data protection tool can implement methods and techniques, similar to the methods and techniques described above, at the application level to calculate a trust score based on the hacker detection model, the user profile, and a new corpus of entity behaviors. In response to the trust score exceeding a threshold trust score, the data protection tool can pass the request for digital resource access to the data store.

### 6.4 Downstream Data Store Behavior Characterization+Digital Resource Release

Generally, the data store can implement methods and techniques, similar to the methods and techniques described above, at the application and data protection tool level to calculate a trust score based on the hacker detection model, the user profile, and new corpus of entity behaviors. In response to the trust score exceeding a threshold trust score, the data store can: identify the entity as an authorized user; access the digital resource from the request; decrypt the digital resource according to the third-level encryption scheme; and pass the digital resource to the data protection tool.

### 6.5 Upstream Digital Resource Decryption+Exposure

Generally, in response to the trust score exceeding a threshold trust score, elements of the system can selectively decrypt the digital resource and return the unencrypted digital resource to the entity at the device.

In one implementation, the data store can, in response to the data store confirming the data store-level trust score exceeds a threshold trust score: retrieve a third-level-encrypted digital resource; decrypt the third level of the third-level-encrypted digital resource, using a data-store-level specific key (or token); and release corresponding second-level-encrypted digital resource to the data protection tool.

In this implementation, the data protection tool can: receive the second-level-encrypted digital resource from the data store; decrypt the second level of the second-level-encrypted digital resource; and release the corresponding first-level-encrypted digital resource to the application.

The application can then: receive the first-level-encrypted digital resource; decrypt the first level of the first-level-encrypted digital resource; and release, expose, or render the corresponding unencrypted digital resource to the entity that initiated the request for the digital resource.

In one implementation, the computer system can identify remote machines on which encryption keys are stored for each step of decryption of the digital resource. For example, in response to validation of the entity attempting to access the digital resource, the data store can: identify a first device as hosting the third encryption key; access the third encryption key from the first device; and decrypt the digital resource according to the third encryption key. Similarly, in response to validation of the entity attempting to access the digital resource, the data protection tool can: identify a second device as hosting the second encryption key; access the second encryption key from the second device; and decrypt the digital resource according to the second encryption key. Yet similarly, the application can: identify a first device as hosting the first encryption key; access the first encryption key from the first device; and decrypt the digital resource according to the first encryption key.

Therefore, by pseudorandomly selecting and remotely storing encryption keys on distributed devices across the computer network, the computer system can increase security of the digital resource by decreasing a likelihood of an inauthentic entity discovering the correct encryption keys for the digital resource.

### 7. Digital Resource Retrieval Variation: Upstream Behavior Characterization

As described herein, the system can implement downstream behavior characterization. Additionally or alternatively, the system can implement upstream behavior characterization to (re)calculate the trust score for the entity, such as further based on additional entity behaviors collected by the application at the device following receipt of the request for the digital resource at the device.

In one implementation, the application: collects a first corpus of entity behaviors over a first period of time leading up to and/or including a request for access to a digital resource; calculates an application-level trust score for the entity based on these behaviors; and passes the request for the digital resource and the first corpus of entity behaviors to the data protection tool if the trust score for the entity exceeds a threshold trust score. Following the first time period, the application can collect and stream additional entity behaviors to the data protection tool and/or to the data store.

In this implementation, the data protection tool then: receives the request for access to the digital resource, the first corpus of entity behaviors, and the stream of additional entity behaviors from the application; calculates a data protection tool-level trust score for the entity based on these behaviors; and passes the request for the digital resource to the data store if the data protection tool-level trust score for the entity exceeds the threshold trust score.

In this implementation, the data store then: receives the request from the data protection tool, the current corpus of entity behaviors, and the stream of additional entity behaviors from the data protection tool and/or directly from the application; calculates a data store-level trust score for the entity based on these behaviors; and decrypts the third-level-encrypted digital resource with the data store-decryption key or token and passes the second-level-encrypted digital resource to the data protection tool if the data store-level trust score for the entity exceeds the threshold trust score.

In this implementation, the data protection tool then: receives the second-level-encrypted digital resource from the data store, the current corpus of entity behaviors, and the stream of additional entity behaviors from data store and/or directly from the application; calculates a new data store-level trust score for the entity based on these behaviors; and decrypts the second-level-encrypted digital resource with the data protection tool-decryption key or token and passes the first-level-encrypted digital resource to the application if the new data store-level trust score for the entity exceeds the threshold trust score. The application then: receives the first-level-encrypted digital resource from the data store; calculates a new application-level trust score for the entity based on the current corpus of behaviors collected for the entity; and decrypts the first-level-encrypted digital resource with the application decryption key or token and releases the decrypted digital resource to the entity if the new application-level trust score for the entity exceeds the threshold trust score.

Therefore, each of the application, data protection tool, and the data store can recalculate trusts scores before executing each subsequent action—to decrypt and then return the decrypted digital resource to the entity—based on additional behaviors of the entity collected by the application between receipt of request for the digital resource from the entity and delivery of the digital resource to the entity. Thus, the system can leverage a delay between receipt of the request for the digital resource and delivery of the digital resource to the user to collect more behaviors of the entity, to recalculate trust scores for the entity based on a larger corpus of entity behavior data, and to deliver the digital resource to the entity only if the entity's behaviors, even after requesting the digital resource, sufficiently match (or “comport”) with expects behaviors of an authentic user.

### 8. Voting: Distributed Behavior Characterization and Trust Score Calculation

In one variation, the system includes a network of (e.g., 1,000) distributed (real or virtual) machines (or assets, endpoints) (hereinafter “scoring machines”) configured to: receive a corpus of behaviors from an instance of the application; and calculate a trust score based on the corpus of behaviors.

In this variation, following receipt of a request for the digital resource from an entity, the application can implement methods and techniques described above to locally calculate a local trust score based on entity behaviors captured by the application before and/or after receiving the request for the digital resource. The application can additionally or alternatively: (pseudo)pseudorandomly select a subset of (e.g., five) scoring machines within the network; serve the current corpus of entity behaviors and a request for a distributed trust score to each scoring machine in this subset of scoring machines; receive a set of distributed trust scores from this set of scoring machines; combine these distributed trust scores and/or the local trust score into a composite trust score for the entity; and pass the request for the digital resource to the data protection tool if the composite trust score exceeds the threshold trust score. For example, the application can combine these distributed trust scores and/or the local trust score into a composite trust score for the entity by: discarding the highest trust score; discarding the lowest trust score; and calculating the composite trust score based on an average of the remaining trust scores.

In particular, in this implementation, at the application, the computer system can: access a population of devices associated with the computer network; select a first subset of devices in the population of devices; for each device in the first subset of devices, pass the first set of entity behaviors to the device and receive a trust score, in a first set of trust scores, from the device; and calculate the first trust score based on the first set of trust scores.

Similarly, the data protection tool can: select a second subset of devices in the population of devices; for each device in the second subset of devices, pass the first set of entity behaviors to the device and receive a trust score, in a second set of trust scores, from the device; and calculate the second trust score based on the second set of trust scores.

Yet similarly, the data store can: select a third subset of devices in the population of devices; for each device in the third subset of devices, pass the first set of entity behaviors to the device; receive a trust score, in a third set of trust scores, from the device; and calculate the third trust score based on the third set of trust scores.

Therefore, the system can prevent hacking or spoofing of the trust score by outsourcing calculation of the trust score by an unpredictable subset of scoring machines within the network. The application can additionally or alternatively implement processes as described herein when updating the trust score during upstream behavior characterization for the entity. The data protection tool and the data store can implement similar methods and techniques to outsource calculation of their trust scores by other (i.e., different) unpredictable subsets of scoring machines within the network during downstream and/or upstream behavior characterization for the entity.

### 9. Distributed Ledger Technology Storage and Access

Generally, the system can store and access encryption keys, such as in local or remote memory stores, for decryption of sensitive digital resources in downstream processes of returning a requested digital resource.

In one implementation, the application: selects an application encryption key in response to receiving a digital resource to store; applies the application encryption key to the digital resource via encrypting the digital resource; associates the digital resource with an identification of the application encryption key; and passes the digital resource to the data protection tool. The data protection tool then: selects a data protection tool encryption key in response to receiving the digital resource; applies the data protection tool encryption key to the digital resource via encrypting the digital resource; associates the digital resource with an identification of the data protection tool encryption key; and passes the digital resource to the data store. The data store: selects a data store encryption key in response to receiving the digital resource; applies the data store encryption key to the digital resource via encrypting the digital resource; associates the digital resource with an identification of the data store encryption key; and stores the digital resource.

In one example, the application can: generate a first encryption key according to the first encryption scheme; generate a first token representing the first encryption key; select a first remote computer system, in a population of remote computer systems, for decentralized storage of the first token; and transmit the first token to the first remote computer system; In this example, the data protection tool can: generate a second encryption key according to the second encryption scheme; generate a second token representing the second encryption key; select a second remote computer system, in the population of remote computer systems, for decentralized storage of the second token; and transmit the second token to the second remote computer system. The data store can: generate a third encryption key according to the third encryption scheme; generate a third token representing the third encryption key; select a third remote computer system, in the population of remote computer systems, for decentralized storage of the third token; and transmit the third token to the third remote computer system.

In this example, in response to validation of an entity attempting to access the digital resource, the data store can: identify the third remote computer system as hosting the third token for the third encryption key; access the third encryption key based on the third token; and decrypt the digital resource according to the third encryption key. The data protection tool can then: identify the second remote computer system as hosting the second token for the second encryption key; access the second encryption key based on the second token; and decrypt the digital resource according to the second encryption key. The application can then: identify the first remote computer system as hosting the first token for the first encryption key; access the first encryption key based on the first token; and decrypt the digital resource according to the first encryption key.

In one variation, the system can store the set of decryption keys on a decentralized (or distributed) ledger (e.g., a public blockchain). For example, during a digital resource request, in response to the data store confirming an authentic user via a data store trust score exceeding a trust score threshold, the data store can: retrieve the data store decryption key from an accurate block in the decentralized ledger (or blockchain); and pass a block address of the data protection tool decryption key to the data protection tool. In response to the data protection tool receiving the block address of the data protection tool encryption key, the data protection tool can retrieve the data protection tool decryption key from the block via the block address; and pass a block address of the application decryption key to the application. In response to the application receiving the block address of the application tool encryption key, the application can retrieve the application decryption key from the block via the block address; decrypt the digital resource; and serve the decrypted digital resource to the user.

In another variation, the system can store the set of decryption keys on a private database of decryption keys. For example, during a digital resource request, in response to the data store confirming an authentic user via a data store trust score exceeding a trust score threshold, the data store can: recall the data store decryption key from the private database, based on the identification of the data store encryption key;

and trigger the private database to release (or send) the data protection tool decryption key to the data protection tool based on the identification of the encryption key associated with the digital resource.

Additionally or alternatively, the data store can return (or send) a code (e.g., uniform resource locator) to the data protection tool associated with the data protection tool encryption key. The data protection tool can: access the data protection tool decryption key from the database based on the code; decrypt the digital resource based on the data protection tool decryption key; and return (or send) a code (e.g., uniform resource locator) to the application associated with the application decryption key.

### 10. Distributed User Profile Storage and Access

In one implementation, the application: stores a local copy of the user profile; and distributes the user profile to the data protection tool, the data store, and/or scoring machines during upstream/downstream digital resource retrieval.

In one variation, the system includes a remote database that can store the user profile associated with a user identifier. In this variation, each of the application, the data protection tool, the data store, and/or the scoring machines can: selectively retrieve copies of the user profile from the remote database in response to fielding a request for a digital resource, such as based on a user identifier collected or specified by the application or associated with the digital resource requested by the entity.

### 11. Threshold Trust Score Calculation

Generally, the system can: calculate a sensitivity score of the requested digital resource, such as based on contents or characteristics of the digital resource; and assign a threshold trust score—to control access to the digital resource—based on (e.g., proportional to) the sensitivity score.

In particular, the computer system can: access a digital resource type of the digital resource; calculate a sensitivity score for the digital resource based on the digital resource type; at the application, calculate the first threshold trust score proportional to the sensitivity score; at the data protection tool, calculate the second threshold trust score, exceeding the first threshold trust score, proportional to the sensitivity score; and, at the data store, calculate the third threshold trust score, exceeding the second threshold trust score, proportional to the sensitivity score.

More specifically, in response to successful download of a digital resource to the data store, the data store can: scan the digital resource for language concepts (or language signals) representing sensitive information (e.g., Social Security numbers, birthdates, banking information, personal health information and medical histories); and calculate a sensitivity score for the digital resource based on a prevalence (e.g., frequency) of such sensitive information signals.

For example, the data store can calculate a sensitivity score based on: the sensitivity of the content in the digital resource (e.g., banking information is a assigned a high sensitivity score, whereas a first name is assigned a low sensitivity score); and/or the volume of sensitive information in the digital resource (e.g., assign a higher sensitivity score for a higher volume of sensitive information).

Additionally or alternatively, the data store can assign a sensitivity score based on a binary scale based on the presence or absence of sensitive data.

Therefore, the system can implement threshold trust scores tuned to the particular type and/or magnitude of sensitive information contained within each digital resource, thereby enabling sensitive digital resources to follow a similar protocol flow, but with differing levels of protection proportional to the level of sensitivity of the content in the digital resource.

### 12. Resource Allocation

Generally, an element of the system can calculate a trust score for a first corpus of entity behaviors, such as at the application, the data protection tool, and/or the data store.

In one implementation, the system can: construct a model for calculating a trust; and implement unique scoring modules on each of the application, data protection tool, and data store.

For example, at the application, the system can implement a low-cost trust scoring module, such as an artificial intelligence model defining a first quantity of nodes. The system can, at the data protection tool: implement a medium-cost trust scoring module, such as an artificial intelligence model defining a second quantity of nodes exceeding the first quantity of nodes. Furthermore, the system can, at the data store, implement a higher-cost trust scoring module, such as an artificial intelligence model defining a third quantity of nodes exceeding the second quantity of nodes.

Therefore, the system can: implement a larger (or more complex) model at downstream locations, wherein each downstream model represents a larger computational load requiring an increasing quantity of computational resources. Thus, the system can identify apparent hackers at the application level and eliminate the need to pass trust score calculation requests to the data protection tool and data store, preserving computational resources. The system can further identify less apparent hackers at the data protection tool level, while still maintaining a low-cost load on computational resources. Thus, implementing increasing computational costs as the workflow moves downstream from the application to the data protection tool to the data store can maintain high processing speeds while also maintaining a high accuracy of the hacker detection models.

In one variation, each of the application, data protection tool, and data store can define unique threshold trust scores. For example, the application can define a first trust score threshold calculated based on a sensitivity score of the digital resource. The data protection tool can define a second trust score threshold, greater than the first trust score threshold, such as calculated based on the sensitivity score of the digital resource. The data store can define a third trust score threshold, greater than the second trust score threshold, such as calculated based on the sensitivity score of the digital resource. Therefore, by implementing an increasing trust score threshold at each level of the system, the system can further mitigate computational load by passing the computational load downstream.

### 13. Encryption Method Variation

In one variation, the system can implement distinct methods of encryption at each level of encryption for storing encryption keys. For example: the application can implement a first type of encryption (e.g., elliptic curve cryptography) for the first encryption key; the data protection tool can implement a second type of encryption (e.g., hash functions) for the second encryption key; and the data store can implement a third type of encryption (e.g., quantum key distribution) for the third encryption key.

Therefore, the system can further prevent a hacker from accessing the encryption keys necessary to access the digital resource by requiring the hacker to utilize unique decryption systems for each type of encryption, and, thereby, reduce the likelihood of an unauthorized user gaining access to a digital resource.

### 14. Hacker Monitoring and Learning

As described above, each of the application, the data protection tool, and the data store can individually calculate trust scores for the entity based on similarities (and/or differences) between: the entity behaviors collected before, during and/or (shortly) after entering the request to access the digital resource at the application and authentic user behaviors stored in the user profile.

In response to one (or more) of the application, the data protection tool, and the data store calculating a trust score less than a threshold trust score, the system can identify the entity as an invalid or inauthentic entity (i.e., a “hacker”) and thus trigger the application, the data protection tool, and the data store to cooperate to return a decoy digital resource to the hacker.

In particular, in one implementation at the application, the computer system can: receive a second request to access the digital resource from a second entity; record a second set of entity behaviors representing interactions between the second entity and the application; calculate a first trust score for the entity based on similarities between the first set of user behaviors and the second set of entity behaviors; and, in response to the fourth trust score exceeding the first threshold trust score, pass the second request to the data protection tool. Additionally, in this implementation at the data protection tool, the computer system can: calculate a second trust score for the second entity based on similarities between the first set of user behaviors and the second set of entity behaviors; and, in response to the second trust score exceeding the second threshold trust score, pass the request to the data store. Furthermore, in this implementation at the data protection tool, the computer system can: calculate a third trust score for the entity based on similarities between the first set of user behaviors and the second set of entity behaviors; and, in response to the third trust score falling below the third threshold trust score, identify a digital resource type of the digital resource, access a decoy digital resource of the digital resource type, and serve the decoy digital resource, in place of the digital resource, to the second entity.

Additionally or alternatively, the computer system can detect an inauthentic entity at the data protection tool. In particular, during a third time period and at the application, the computer system can: receive a second request to access the digital resource from a second entity; record a second set of entity behaviors representing interactions between the second entity and the application; calculate a fourth trust score for the entity based on similarities between the first set of user behaviors and the second set of entity behaviors; and, in response to the fourth trust score exceeding the first threshold trust score, pass the second request to the data protection tool.

The computer system can, at the data protection tool, calculate a fifth trust score for the second entity based on similarities between the first set of user behaviors and the second set of entity behaviors and, in response to the fifth trust score falling below the second threshold trust score: identify a digital resource type of the digital resource; access a decoy digital resource of the digital resource type; and serve the decoy digital resource, in place of the digital resource, to the second entity.

Additionally or alternatively, the computer system can detect an inauthentic entity at the application. In particular, at the application, the computer system can: receive a second request to access the digital resource from a second entity; record a second set of entity behaviors representing interactions between the second entity and the application; and calculate a fourth trust score for the entity based on similarities between the first set of user behaviors and the second set of entity behaviors. In response to the fourth trust score falling below the first threshold trust score, the application can then: identify a digital resource type of the digital resource; access a decoy digital resource of the digital resource type; and serve the decoy digital resource, in place of the digital resource, to the second entity.

In one variation, the computer system can implement methods and techniques described herein to detect an inauthentic entity based on entity attributes. For example, at the application, the computer system can: receive a second request to access the live data stream from a second entity; record a second set of entity attributes; calculate a fourth trust score for the entity based on similarities between the first set of user attributes and the second set of entity attributes; and, in response to the fourth trust score exceeding the first threshold trust score, passing the second request to the data protection tool. At the data protection tool, the computer system can then: calculate a fifth trust score for the second entity based on similarities between the first set of user attributes and the second set of entity attributes; and, in response to the fifth trust score exceeding the second threshold trust score, passing the request to the data distribution system. At the data distribution system, the computer system can then: calculate a sixth trust score for the entity based on similarities between the first set of user attributes and the second set of entity attributes; and, in response to the sixth trust score falling below the third threshold trust score, access a decoy data stream and stream the decoy data stream, in place of the live data stream, to the second entity.

In one variation, the computer system can: detect an inauthentic entity based on a hacker detection model; and update this hacker detection model based on behaviors and/or attributes recorded at the application associated with the inauthentic entity.

In one implementation, the computer system can: calculate the fourth trust score for the second entity based on similarities between the first set of user behaviors (or attributes) and the second set of entity behaviors (or attributes) and a hacker detection model; and, in response to invalidation of the second entity, update the hacker detection model according to the second set of entity behaviors.

Additionally or alternatively, the computer system can: at the application, calculate the fourth trust score for the second entity based on similarities between the first set of user attributes and the second set of entity attributes and a hacker detection model; at the data protection tool, calculate the fifth trust score for the second entity based on similarities between the first set of user attributes and the second set of entity attributes and the hacker detection model; at the data store and/or data distribution system, calculate the sixth trust score for the second entity based on similarities between the first set of user attributes and the second set of entity attributes and the hacker detection model; and update the hacker detection model according to the second set of entity behaviors in response to the sixth trust score falling below the third threshold trust score.

In one example, following receipt of the request to access the digital resource from the entity, the application can continue to record behaviors of the entity. Upon the system identifying the entity as a hacker, the application can: further record behaviors of the hacker, such as specific interactions of the hacker with the decoy digital resource; aggregate the behavior recorded before, during, and after receiving the request for the digital resource and before, during, and after delivery of the decoy digital resource to the hacker into a corpus of hacker behaviors; and return the corpus of hacker behaviors to the data protection tool (or the data store or other remote computer system).

The data protection tool (or the data store or other remote computer system) can then: append the corpus of hacker behaviors to a large hacker behavior dataset; retrain the hacker detection model (e.g., application—, data protection tool—, and data store-specific hacker detection models) based on this updated hacker behavior dataset; and distribute this retrained hacker detection model to each of the application, the data protection tool, and the data store.

The system can thus update the hacker detection model over time to enable the application, the data protection tool, and the data store to identify a hacker—based on behaviors at a local device—more accurately, in less time, and/or with fewer computational resources while updating the hacker detection model to reflect current hacker behaviors and attack telemetries over time.

### 15. Decoy Digital Resource Selection/Generation

Generally, in response to the hacker requesting a digital resource, the system can access a decoy digital resource to return to an entity identified as a hacker.

In one implementation, the computer system can select a decoy digital resource based on a digital resource type of the target digital resource that the entity is attempting to access. Additionally or alternatively, the computer system can generate a decoy digital resource, such as in real time, in response to detection of the inauthentic entity.

For example, the computer system can: access a set of digital resource characteristics from metadata associated with the digital resource; identify the digital resource type in the set of digital resource characteristics; identify a data size of the digital resource from the set of digital resource characteristics; and generate the decoy digital resource, of the data size, based on the digital resource type.

Additionally or alternatively, the computer system can generate a decoy data stream in real time responsive to inputs by the entity to the application. In particular, the computer system can: identify a data stream type of the live data stream; access a set of inputs to the live data stream from the application, the set of inputs input by the second entity at the application; generate frames of the decoy data stream according to the data stream type and the set of inputs; and stream frames of the decoy data stream according to the set of inputs.

In another example, the computer system can: access a set of data stream characteristics from metadata associated with the data stream; identify a data stream type from the set of data stream characteristics; identify a data size of the data stream from the set of data stream characteristics; and generate the decoy data stream of the data size and the data stream type.

Therefore, by generating a live data stream, which may be perceived as authentic to a bad actor, the computer system can enforce this bad actor's belief that they have successfully attacked and gained control of resources and/or assets of the computer network.

In one variation, the system includes a network (e.g., 1000s) of decoy digital resources (e.g., generic decoy digital resources; prepopulated decoy digital resources). In response to a request for a digital resource and in response to the request originating from an entity identified as a hacker, the system can: access size information for the requested digital resource; access a decoy digital resource in the network of decoy digital resources approximating the size of the requested digital resource; and return the decoy digital resource to the hacker.

In another variation, in response to an authentic digital resource successfully stored on the data store, the system can: identify language concepts (or “language signals”) associated with sensitive information stored in the authentic digital resource; generate a tag representing presence of each language concept for each language concept found in the authentic digital resource; generate a decoy digital resource associated with the authentic digital resource, the decoy digital resource including decoy, but similar, data (e.g., by using a large language model to find and replace a real Social Security number with a decoy Social Security number); pair the decoy digital resource with the authentic digital resource; and, in response to a request for a digital resource and the request originating from an entity identified as a hacker, return the decoy digital resource associated with the authentic digital resource.

Additionally or alternatively, when returning the decoy digital resource to the hacker, the system can implement the same methods used to encrypt and decrypt authentic digital resources to the decoy digital resource, thereby simulating the process of serving a real digital resource to the hacker, such that the processes of serving an authentic digital resource and serving a decoy digital resource are identical. Thus, the system can implement a similar or identical process for serving both authentic and decoy digital resources to authentic entities and hackers alike in order: to reduce likelihood that a hacker recognizes that the system has identified the hacker; to increase likelihood that the hacker interacts with the decoy digital resource as if the digital resource were authentic; to capture representative behaviors of the hacker interfacing with a digital resource perceived by the hacker as authentic; and to improve accuracy of the hacker detection model by refining the hacker detection model based on these hacker behaviors.

Therefore, the system can return digital resources to the hacker without revealing sensitive information by returning unique decoy digital resources for each access attempt, such that the hacker may continue to try to access additional digital resources. Thus, the system can continue to monitor and collect behavior data from the hacker and populate the corpus of training data to train the application, data protection tool, and data store trust scoring modules to increase accuracy of identifying hackers by assigning low trust scores to entities exhibiting behaviors similar to identifiable hackers.

### 16. Parallel Trust Score Calculation

In one implementation, in response to a digital resource access request, at the application, the system can: capture and store a corpus of entity behaviors; calculate a trust score; and send the first trust score and the corpus of entity behaviors to the data protection tool. The data protection tool can: calculate a second trust score; and send the second trust score and the corpus of entity behaviors to the data store. The data store can: calculate a third trust score; calculate a composite trust score based on the first trust score, the second trust score, and the third trust score; and, in response to the composite trust score exceeding a trust score threshold, initiate the upstream workflow to retrieve and decrypt the digital resource to return to the user.

### 17. Multi-Factor Authentication

In one variation, in response to the data protection tool decrypting the digital resource, the system can: generate a user authentication prompt via a message handler (e.g., a remote machine, the application, the data protection tool, a remote server); and send an authentication prompt to a second device associated with a user (or to an administrator). The system can then, in response to confirmation from the second device or administrator to release the digital resource to the application: prompt the application to decrypt and serve the digital resource to entity.

Additionally or alternatively, in response to the user or administrator declining the authentication prompt (indicating that the digital resource request is sourced from an inauthentic user), the system can: send a trigger to the data store to access a decoy digital resource; pass the decoy digital resource to the entity; and prompt the data protection tool to discard the (authentic) digital resource.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions. As a person skilled in the art will recognize from the previous detailed decryption and from the figures and claims, modifications and changes can be made to the embodiments of the invention without departing from the scope of this invention as defined in the following claims.

1. A method comprising:
during a first time period:
recording a first set of user behaviors representing authentic interactions between a first user and a set of devices connected to a computer network;
at an application executing on a first device in the computer network:
accessing a digital resource;
encrypting the digital resource according to a first encryption scheme; and
passing the digital resource to a data protection tool;
at the data protection tool:
encrypting the digital resource according to a second encryption scheme; and
passing the digital resource to a data store;
at the data store:
encrypting the digital resource according to a third encryption scheme; and
storing the digital resource encrypted according to the first encryption scheme, the second encryption scheme, and the third encryption scheme; and
during a second time period:
at the application:
receiving a request to access the digital resource from a first entity;
recording a first set of entity behaviors representing interactions between the first entity and the application;
calculating a first trust score for the first entity based on similarities between the first set of user behaviors and the first set of entity behaviors; and
in response to the first trust score exceeding a first threshold trust score, passing the request to the data protection tool;
at the data protection tool:
calculating a second trust score for the first entity based on similarities between the first set of user behaviors and the first set of entity behaviors; and
in response to the second trust score exceeding a second threshold trust score, passing the request to the data store;
at the data store:
calculating a third trust score for the first entity based on similarities between the first set of user behaviors and the first set of entity behaviors; and
in response to the third trust score exceeding a third threshold trust score:
identifying the first entity as the first user;
accessing the digital resource;
decrypting the digital resource according to the third encryption scheme; and
passing the digital resource to the data protection tool;
at the data protection tool, in response to receipt of the digital resource from the data store:
decrypting the digital resource according to the second encryption scheme; and
passing the digital resource to the application; and
at the application, in response to receipt of the digital resource from the data protection tool:
decrypting the digital resource according to the first encryption scheme; and
serving the digital resource to the first entity.

2. The method of claim 1, further comprising, during a third time period:
at the application:
receiving a second request to access the digital resource from a second entity;
recording a second set of entity behaviors representing interactions between the second entity and the application;
calculating a fourth trust score for the second entity based on similarities between the first set of user behaviors and the second set of entity behaviors; and
in response to the fourth trust score exceeding the first threshold trust score, passing the second request to the data protection tool;
at the data protection tool:
calculating a fifth trust score for the second entity based on similarities between the first set of user behaviors and the second set of entity behaviors; and
in response to the fifth trust score exceeding the second threshold trust score, passing the request to the data store; and
at the data store:
calculating a sixth trust score for the second entity based on similarities between the first set of user behaviors and the second set of entity behaviors; and
in response to the sixth trust score falling below the third threshold trust score:
identifying the second entity as other than the first user;
identifying a digital resource type of the digital resource;
accessing a decoy digital resource of the digital resource type; and
serving the decoy digital resource, in place of the digital resource, to the second entity.

3. The method of claim 1, further comprising, during a third time period:
at a second instance of the application:
receiving a second request to access the digital resource from a second entity;
recording a second set of entity behaviors representing interactions between the second entity and the application;
calculating a fourth trust score for the second entity based on similarities between the first set of user behaviors and the second set of entity behaviors; and
in response to the fourth trust score exceeding the first threshold trust score, passing the second request to the data protection tool; and
at the data protection tool:
calculating a fifth trust score for the second entity based on similarities between the first set of user behaviors and the second set of entity behaviors; and
in response to the fifth trust score falling below the second threshold trust score:
identifying the second entity as other than the first user;
identifying a digital resource type of the digital resource;
accessing a decoy digital resource of the digital resource type; and
serving the decoy digital resource, in place of the digital resource, to the second entity.

4. The method of claim 1, further comprising, during a third time period:
at the application:
receiving a second request to access the digital resource from a second entity;
recording a second set of entity behaviors representing interactions between the second entity and the application;
calculating a fourth trust score for the second entity based on similarities between the first set of user behaviors and the second set of entity behaviors; and
in response to the fourth trust score falling below the first threshold trust score:
identifying the second entity as other than the first user;
identifying a digital resource type of the digital resource;
accessing a decoy digital resource of the digital resource type; and
serving the decoy digital resource, in place of the digital resource, to the second entity.

5. The method of claim 4:
wherein calculating the fourth trust score for the second entity based on similarities between the first set of user behaviors and the second set of entity behaviors comprises calculating the fourth trust score for the second entity based on:
similarities between the first set of user behaviors and the second set of entity behaviors; and
a hacker detection model; and
further comprising updating the hacker detection model according to the second set of entity behaviors.

6. The method of claim 4:
wherein identifying the digital resource type of the digital resource comprises:
accessing a set of digital resource characteristics from metadata associated with the digital resource; and
identifying the digital resource type in the set of digital resource characteristics; and
wherein accessing the decoy digital resource of the digital resource type comprises:
retrieving a data size of the digital resource from the set of digital resource characteristics; and
generating the decoy digital resource, approximating the data size, of the digital resource type.

7. The method of claim 1:
further comprising, at the application:
recording a second set of entity behaviors representing interactions between the first entity and the application after calculation of the first trust score; and
serving the second set of entity behaviors to the data protection tool;
wherein calculating the second trust score at the data protection tool comprises calculating the second trust score for the first entity based on:
similarities between the first set of user behaviors and the first set of entity behaviors; and
similarities between the first set of user behaviors and the second set of entity behaviors;
further comprising, at the application:
in response to calculation of the second trust score, recording a third set of entity behaviors representing interactions between the first entity and the application; and
serving the third set of entity behaviors to the data store; and
wherein calculating the third trust score at data store comprises calculating the third trust score for the first entity based on:
similarities between the first set of user behaviors and:
the first set of entity behaviors;
the second set of entity behaviors; and
the third set of entity behaviors.

8. The method of claim 1:
wherein, at the application, passing the digital resource to the data protection tool during the first time period comprises:
accessing a population of devices associated with the computer network;
pseudorandomly selecting a second device in the population of devices; and
passing the digital resource to the data protection tool at the second device; and
wherein, at the data protection tool, passing the digital resource to the data store during the first time period comprises:
pseudorandomly selecting a third device in the population of devices; and
passing the digital resource to the data protection tool at the third device.

9. The method of claim 1:
wherein encrypting the digital resource according to the first encryption scheme at the application comprises:
accessing a population of devices associated with the computer network;
pseudorandomly selecting a second device in the population of devices; and
storing a first encryption key, for the first encryption scheme, at the second device;
wherein encrypting the digital resource according to the second encryption scheme at the data protection tool comprises:
pseudorandomly selecting a third device in the population of devices; and
storing a second encryption key, for the second encryption scheme, at the third device;
wherein encrypting the digital resource according to the third encryption scheme at the data store comprises:
pseudorandomly selecting a fourth device in the population of devices; and
storing a third encryption key, for the third encryption scheme, at the fourth device;
wherein decrypting the digital resource according to the third encryption scheme at the data store comprises:
identifying the fourth device as hosting the third encryption key;
accessing the third encryption key from the fourth device; and
decrypting the digital resource according to the third encryption key;
wherein decrypting the digital resource according to the second encryption scheme at the data protection tool comprises:
identifying the third device as hosting the second encryption key;
accessing the second encryption key from the third device; and
decrypting the digital resource according to the second encryption key; and
wherein decrypting the digital resource according to the first encryption scheme at the application comprises:
identifying the second device as hosting the first encryption key;
accessing the first encryption key from the second device; and
decrypting the digital resource according to the first encryption key.

10. The method of claim 1:
wherein calculating the first trust score at the application comprises:
selecting a first subset of devices in a population of devices associated with the computer network;
for each device in the first subset of devices:
serving the first set of entity behaviors to the device; and
receiving a trust score, in a first set of trust scores, from the device; and
calculating the first trust score based on the first set of trust scores;
wherein calculating the second trust score at the data protection tool comprises:
selecting a second subset of devices in the population of devices;
for each device in the second subset of devices:
passing the first set of entity behaviors to the device; and
receiving a trust score, in a second set of trust scores, from the device; and
calculating the second trust score based on the second set of trust scores; and
wherein calculating the third trust score at the data store comprises:
selecting a third subset of devices in the population of devices;
for each device in the third subset of devices:
passing the first set of entity behaviors to the device; and
receiving a trust score, in a third set of trust scores, from the device; and
calculating the third trust score based on the third set of trust scores.

11. The method of claim 1:
wherein encrypting the digital resource according to the first encryption scheme at the application comprises:
generating a first encryption key according to the first encryption scheme;
generating a first token representing the first encryption key;
selecting a first remote computer system, in a population of remote computer systems, for decentralized storage of the first token; and
serving the first token to the first remote computer system;
wherein encrypting the digital resource according to the second encryption scheme at the data protection tool comprises:
generating a second encryption key according to the second encryption scheme;
generating a second token representing the second encryption key;
selecting a second remote computer system, in the population of remote computer system, for decentralized storage of the second token; and
serving the second token to the second remote computer system;
wherein encrypting the digital resource according to the third encryption scheme at the data store comprises:
generating a third encryption key according to the third encryption scheme;
generating a third token representing the third encryption key;
selecting a third remote computer system, in the population of remote computer system, for decentralized storage of the third token; and
serving the third token to the third remote computer system;
wherein decrypting the digital resource according to the third encryption scheme at the data store comprises:
identifying the third remote computer system as hosting the third token for the third encryption key;
accessing the third encryption key based on the third token; and
decrypting the digital resource according to the third encryption key;
wherein decrypting the digital resource according to the second encryption scheme at the data protection tool comprises:
identifying the second remote computer system as hosting the second token for the second encryption key;
accessing the second encryption key based on the second token; and
decrypting the digital resource according to the second encryption key; and
wherein decrypting the digital resource according to the first encryption scheme at the application comprises:
identifying the first remote computer system as hosting the first token for the first encryption key;
accessing the first encryption key based on the first token; and
decrypting the digital resource according to the first encryption key.

12. The method of claim 1, further comprising:
accessing a digital resource type of the digital resource;
calculating a sensitivity score for the digital resource based on the digital resource type;
at the application, calculating the first threshold trust score proportional to the sensitivity score;
at the data protection tool, calculating the second threshold trust score, exceeding the first threshold trust score, proportional to the sensitivity score; and
at the data store, calculating the third threshold trust score, exceeding the second threshold trust score, proportional to the sensitivity score.

13. A method comprising:
during a first time period:
generating a first set of user attributes representing an authentic user;
at an application executing on a first device:
accessing a live data stream;
encrypting the live data stream according to a first encryption scheme; and
passing the live data stream to a data protection tool;
at the data protection tool:
encrypting the live data stream according to a second encryption scheme; and
passing the live data stream to a data distribution system;
at the data distribution system:
encrypting the live data stream according to a third encryption scheme; and
hosting the live data stream encrypted according to the first encryption scheme, the second encryption scheme, and the third encryption scheme; and
during a second time period:
at the application:
receiving a request to access the live data stream from a first entity;
recording a first set of entity attributes;
calculating a first trust score for the first entity based on similarities between the first set of user attributes and the first set of entity attributes; and
in response to the first trust score exceeding a first threshold trust score, passing the request to the data protection tool;
at the data protection tool:
calculating a second trust score for the first entity based on similarities between the first set of user attributes and the first set of entity attributes; and
in response to the second trust score exceeding a second threshold trust score, passing the request to the data distribution system;
at the data distribution system:
calculating a third trust score for the first entity based on similarities between the first set of user attributes and the first set of entity attributes; and
in response to the third trust score exceeding a third threshold trust score:
accessing the live data stream;
decrypting the live data stream according to the third encryption scheme; and
passing the live data stream to the data protection tool;
at the data protection tool, in response to receipt of the live data stream from the data store:
decrypting the live data stream according to the second encryption scheme; and
passing the digital resource to the application; and
at the application, in response to receipt of the live data stream from the data protection tool:
decrypting the live data stream according to the first encryption scheme; and
serving the data store for the first entity.

14. The method of claim 13, further comprising, during a third time period succeeding the first time period:
at the application:
receiving a second request to access the live data stream from a second entity;
recording a second set of entity attributes;
calculating a fourth trust score for the second entity based on similarities between the first set of user attributes and the second set of entity attributes; and
in response to the fourth trust score exceeding the first threshold trust score, passing the second request to the data protection tool;
at the data protection tool:
calculating a fifth trust score for the second entity based on similarities between the first set of user attributes and the second set of entity attributes; and
in response to the fifth trust score exceeding the second threshold trust score, passing the request to the data distribution system; and
at the data distribution system:
calculating a sixth trust score for the second entity based on similarities between the first set of user attributes and the second set of entity attributes; and
in response to the sixth trust score falling below the third threshold trust score:
identifying the second entity as other than the first user;
accessing a decoy data stream; and
serving the decoy data stream, in place of the live data stream, to the second entity.

15. The method of claim 14:
wherein calculating the fourth trust score for the second entity based on similarities between the first set of user attributes and the second set of entity attributes comprises calculating the fourth trust score for the second entity based on:
similarities between the first set of user attributes and the second set of entity attributes; and
a hacker detection model;
wherein calculating the fifth trust score for the second entity based on similarities between the first set of user attributes and the second set of entity attributes comprises calculating the fifth trust score for the second entity based on:
similarities between the first set of user attributes and the second set of entity attributes; and
the hacker detection model;
wherein calculating the sixth trust score for the second entity based on similarities between the first set of user attributes and the second set of entity attributes comprises calculating the sixth trust score for the second entity based on:
similarities between the first set of user attributes and the second set of entity attributes; and
the hacker detection model; and
further comprising updating the hacker detection model according to the second set of entity attributes in response to the sixth trust score falling below the third threshold trust score.

16. The method of claim 14:
wherein accessing the decoy data stream of the data stream type comprises:
identifying a data stream type of the live data stream;
accessing a set of inputs to the live data stream from the application, the set of inputs input by the second entity at the application; and
generating a first sequence of frames according to the data stream type and the set of inputs; and
wherein serving the decoy data stream, in place of the live data stream, to the second entity comprises serving the sequence of frames to the second entity.

17. The method of claim 13:
wherein generating the first set of user attributes representing the authentic user for the computer network comprises:
accessing a first geospatial location for the authentic user;
accessing a first set of login credentials for the authentic user; and
aggregating the first location and the first set of login credentials into the first set of user attributes;
wherein recording the first set of entity attributes at the application comprises:
accessing a second geospatial location for the first entity; and
accessing a second set of login credentials for the first entity; and
wherein calculating the first trust score for the first entity based on similarities between the first set of user attributes and the first set of entity attributes comprises:
calculating a first similarity between the first geospatial location for the authentic user and the second geospatial location for the first entity;
calculating a second similarity between the first set of login credentials for the authentic user and the second set of login credentials for the first entity; and
calculating the first trust score proportional to the first similarity and the second similarity.

18. The method of claim 13, further comprising:
identifying a data stream type of the live data stream;
calculating a sensitivity score for the live data stream based on the data stream type;
at the application, calculating the first threshold trust score proportional to the sensitivity score;
at the data protection tool, calculating the second threshold trust score, exceeding the first threshold trust score, proportional to the sensitivity score; and
at the data store, calculating the third threshold trust score, exceeding the second threshold trust score, proportional to the sensitivity score.

19. A method comprising:
during a first time period:
at an application executing on a first device:
accessing a data stream;
encrypting the data stream according to a first encryption scheme; and
passing the data stream to a data protection tool;
at the data protection tool:
encrypting the data stream according to a second encryption scheme; and
passing the data stream to a data store;
at the data store:
encrypting the data stream according to a third encryption scheme; and
storing the data stream encrypted according to the first encryption scheme, the second encryption scheme, and the third encryption scheme; and
during a second time period:
at the application:
receiving a request to access the data stream from a first entity;
accessing a first set of user attributes representing an authentic user;
accessing a first set of entity attributes;
calculating a first trust score for the first entity based on the first set of user attributes and the first set of entity attributes; and
in response to the first trust score falling below a first threshold trust score:
identifying a data stream type of the data stream;
generating a decoy data stream of the data stream type; and
serving the decoy data stream to the first entity.

20. The method of claim 19, wherein generating the decoy data stream of the data stream type comprises:
accessing a set of data stream characteristics from metadata associated with the data stream;
identifying a data stream type from the set of data stream characteristics;
identifying a data size of the data stream from the set of data stream characteristics; and
generating the decoy data stream of the data size and the data stream type.
